(19) United States
(12) Patent Application Publication
(10) Pub. No.: US 2023/0128728 A1
(43) Pub. Date: Apr. 27, 2023

(54) AUTOMATED POLICY PROPAGATION FOR ASSOCIATED PROCESS DEFINITION FILES AND PROCESS AUTOMATION FILES

(71) Applicant: Nintex UK Ltd., London (GB)

(72) Inventor: Dmitry Shuvaev, Lincoln (NZ)

(21) Appl. No.: 17/510,693

(22) Filed: Oct. 26, 2021

(51) Int. Cl. G06Q 10/06; G06F 16/11

(52) U.S. Cl. CPC G06Q 10/06316; G06F 16/116

(57) ABSTRACT

Methods and systems for improved policy update propagation are provided. In one aspect, a method is provided that includes receiving a process definition file and a process automation file, which may both be associated with a particular computing process. A mapping may be generated between individual elements of both files. An updated process definition file may be received and a plurality of differences may be determined between the updated process definition file and the process definition file. An ordered list of transformation operations may be generated based on the plurality of differences and applied to the process automation file to generate an updated process automation file. The updated process automation file may then be deployed.

### BACKGROUND

Business process management may include one or both of defining a business process and implementing one or more computing processes that automatically execute all or part of the business process. In certain implementations, process definitions and process automation for the same business process may be stored in separate files.

### SUMMARY

The present disclosure presents new and innovative systems and methods for improved policy update propagation. In a first aspect, a method is provided that includes receiving a process definition file and a process automation file. Each of the process definition file and the process automation file may be associated with a particular computing process. The method may also include generating a mapping between individual elements of the process definition file and the process automation file and receiving an updated process definition file. A plurality of differences between the individual elements of the updated process definition file and individual elements of the process definition file and be determined and used to generate an ordered list of transformation operations. The ordered list of transformation operations may be applied to the process automation file to generate an updated process automation file and the updated process automation file may be deployed.

In a second aspect according to the first aspect, unique identifiers (IDs) are associated with at least a subset of the individual elements of the process definition file and at least a subset of the individual elements of the process automation file. The mapping may also store indications of corresponding elements in the process definition file and the process automation file as pairs of unique IDs.

In a third aspect according to any of the first and second aspects, the individual elements of the process definition file and/or the individual elements of the process automation file include an ordered list of activities, tasks, and links. Activities may include one or more tasks and links may identify additional process definition files and/or process automation files necessary to define the particular computing process.

In a fourth aspect according to the third aspect, the plurality of differences include at least one of an added activity, a removed activity, an added task, a removed task, an added link, a removed link, a change in hierarchical organization for an existing activity, a change in hierarchical organization for an existing task, and/or a change in hierarchical organization for an existing link.

In a fifth aspect according to any of the first through fourth aspects, the ordered list of transformation operations to generate the updated process automation file includes (1) removing child elements from the process automation file that correspond to child elements in the process definition file that are not present in the updated process definition file and (2) adding parent elements to the process automation file that correspond to parent elements in the updated process definition file that are not present in the process definition file. The ordered list of transformation operations may also include (3) moving child elements in the process automation file that correspond to child elements in the updated process definition file with different parent elements than in the process definition file and (4) removing parent elements from the process automation file that correspond to parent elements in the process definition file that are not present in the updated process definition file. The ordered list of transformation operations may further include (5) adding child elements to the process automation file that correspond to child elements in the updated process definition file that are not present in the process definition file, (6) reordering child elements within parent elements of the process automation file that correspond to child elements in the updated process definition file that are ordered differently than in the process definition file, and (7) updating contents for individual elements of the process automation file that correspond to individual elements of the updated process definition file whose contents differ from the process definition file.

In a sixth aspect according to the fifth aspect, the ordered list of transformation operations are applied in order from (1) to (7).

In a seventh aspect according to any of the fifth and sixth aspects, one or more of the transformation operations (1)-(7) are repeated from lower to higher levels of hierarchical organization of the updated process definition file.

In an eighth aspect according to any of the fifth through seventh aspects, parent elements in the process definition file and/or the updated process definition file are individual elements within the process definition file and/or the updated process definition file that are higher in a hierarchical organization of the process definition file and/or the updated process definition file. Parent elements in the process automation file and/or the updated process automation file may also be individual elements within the process automation file and/or the updated process automation file that are higher in a hierarchical organization of the process automation file and/or the updated process automation file.

In a ninth aspect according to any of the first through eighth aspects, the plurality of differences are determined as at least one of (i) a difference log between the updated process definition file and the process definition file and/or (ii) an ordered list of editing actions performed by a user while updating the process definition file.

In a tenth aspect according to any of the first through ninth aspects, each of the transformation operations corresponds to at least one difference of the plurality of differences.

In an eleventh aspect according to the tenth aspect, the order of transformation operations in the ordered list of transformation operations differs at least in part from the order of the differences in the plurality of differences.

In a twelfth aspect according to any of the first through eleventh aspects, the process automation file implements a portion of the particular computing process and the mapping is generated between a corresponding portion of the process definition file and the process automation file.

In a thirteenth aspect according to the twelfth aspect, the ordered list of transformation operations is generated to include changes to the corresponding portion of the process definition file and exclude changes to other portions of the process definition file.

In a fourteenth aspect according to any of the first through thirteenth aspects, the individual elements of the process definition file describe ownership, policies, and/or decisions for the particular computer processes. The individual elements of the process automation file may be executable to perform the particular computing process.

In a fifteenth aspect, a system is provided that includes a processor and a memory. The memory may store instructions which, when executed by the processor, cause the processor to receive a process definition file and a process automation file, wherein each of the process definition file and the process automation file are associated with a particular computing process generate a mapping between individual elements of the process definition file and the process automation file. The instructions may also cause the processor to receive an updated process automation file, determine a plurality of differences between the individual elements of the updated process automation file and individual elements of the process automation file, and generate an ordered list of transformation operations based on the plurality of differences. The instructions may further cause the processor to apply the ordered list of transformation operations to the process definition file to generate an updated process definition file and deploy the updated process automation file.

In a sixteenth aspect according to the fifteenth aspect, unique identifiers (IDs) are associated with at least a subset of the individual elements of the process definition file and at least a subset of the individual elements of the process automation file. The mapping may store indications of corresponding elements in the process definition file and the process automation file as pairs of unique IDs.

In a seventeenth aspect according to any of the fifteenth and sixteenth aspects, the individual elements of the process definition file and/or the individual elements of the process automation file include an ordered list of activities, tasks, and links. Activities may include one or more tasks, and links may identify additional process definition files and/or process automation files necessary to define the particular computing process.

In an eighteenth aspect according to the seventeenth aspect, the plurality of differences include at least one of an added activity, a removed activity, an added task, a removed task, an added link, a removed link, a change in hierarchical organization for an existing activity, a change in hierarchical organization for an existing task, and/or a change in hierarchical organization for an existing link.

In a nineteenth aspect according to any of the fifteenth through eighteenth aspects, the ordered list of transformation operations to generate the updated process automation file includes (1) removing child elements from the process automation file that correspond to child elements in the process definition file that are not present in the updated process definition file and (2) adding parent elements to the process automation file that correspond to parent elements in the updated process definition file that are not present in the process definition file. The ordered list of transformation operations may also include (3) moving child elements in the process automation file that correspond to child elements in the updated process definition file with different parent elements than in the process definition file and (4) removing parent elements from the process automation file that correspond to parent elements in the process definition file that are not present in the updated process definition file. The ordered list of transformation operations may further include (5) adding child elements to the process automation file that correspond to child elements in the updated process definition file that are not present in the process definition file, (6) reordering child elements within parent elements of the process automation file that correspond to child elements in the updated process definition file that are ordered differently than in the process definition file, and (7) updating contents for individual elements of the process automation file that correspond to individual elements of the updated process definition file whose contents differ from the process definition file.

In a twentieth aspect, a method is provided that includes receiving a first process definition file and a second process definition file. Each of the first process definition file and the second process definition file may be associated with particular computing processes. The method may also include generating a mapping between individual elements of the first process definition file and the second process definition file, receiving a first updated process definition file representing an updated version of the first process definition file, and determining a plurality of differences between the individual elements of the first updated process definition file and individual elements of the first process definition file. The method may further include generating an ordered list of transformation operations based on the plurality of differences, applying the ordered list of transformation operations to the second process definition file to generate a second updated process definition file, and storing the second updated process definition file.

The features and advantages described herein are not all-inclusive and, in particular, many additional features and advantages will be apparent to one of ordinary skill in the art in view of the figures and description. Moreover, it should be noted that the language used in the specification has been principally selected for readability and instructional purposes, and not to limit the scope of the disclosed subject matter.

### BRIEF DESCRIPTION OF THE FIGURES

FIG. 1 illustrates a system for computing process update propagation according to an exemplary embodiment of the present disclosure.

FIG. 2 illustrates a scenario including an example process definition file and an example process automation file according to an exemplary embodiment of the present disclosure.

FIGS. 3A-3B illustrate a scenario including an exemplary computing process update propagation according to an exemplary embodiment of the present disclosure.

FIG. 4 illustrates a method for propagating computing process updates according to an exemplary embodiment of the present disclosure.

FIG. 5 illustrates a method for generating and/or applying transformation operations according to an exemplary embodiment of the present disclosure.

FIG. 6 illustrates an example computer system according to an exemplary embodiment of the present disclosure.

### DETAILED DESCRIPTION OF EXAMPLE EMBODIMENTS

Computerized implementations of business processes may include multiple types of documents and files. In particular, business processes may include one or more associated process definition files and process automation files. The process definition files may define the business process in a human-readable format. The process automation files may include executable steps that are performed by a computing device in order to perform all or part of the business process. Structures of the process definition files and process automation files may typically mirror one another such that one or more tasks or activities in the process definition file have corresponding tasks and activities that are automatically executed according to the process automation file. To ensure that a business process is accurately defined and implemented, changes to the process definition file need to be reflected in changes to the process automation file, and vice versa. Therefore, it is necessary to ensure that both the process definition file and the process automation file for processes are kept up-to-date.

One solution to this problem is to generate a mapping between elements of the process definition file and corresponding elements of the process automation file. The mapping may include unique identifiers for individual elements (e.g., activities, tasks, links) within the process definition file and corresponding individual elements within the process automation file. Subsequently, an updated process definition file may be received, and changes to the updated process definition file may be identified (e.g., by comparing the updated process definition file to the original process definition file). Transformation steps for the process automation file may be generated based on the changes to the updated process definition file. In certain instances, the transformation steps may be generated according to a predetermined order. The transformation operations may be applied to the process automation file to generate an updated process automation file, which may then be deployed in place of the original process automation file. Similar steps may be performed when an updated process automation file is received in order to generate an updated process definition file for the process. In particular, these techniques may be used to bidirectionally propagate changes to either of the process definition file and the process automation file.

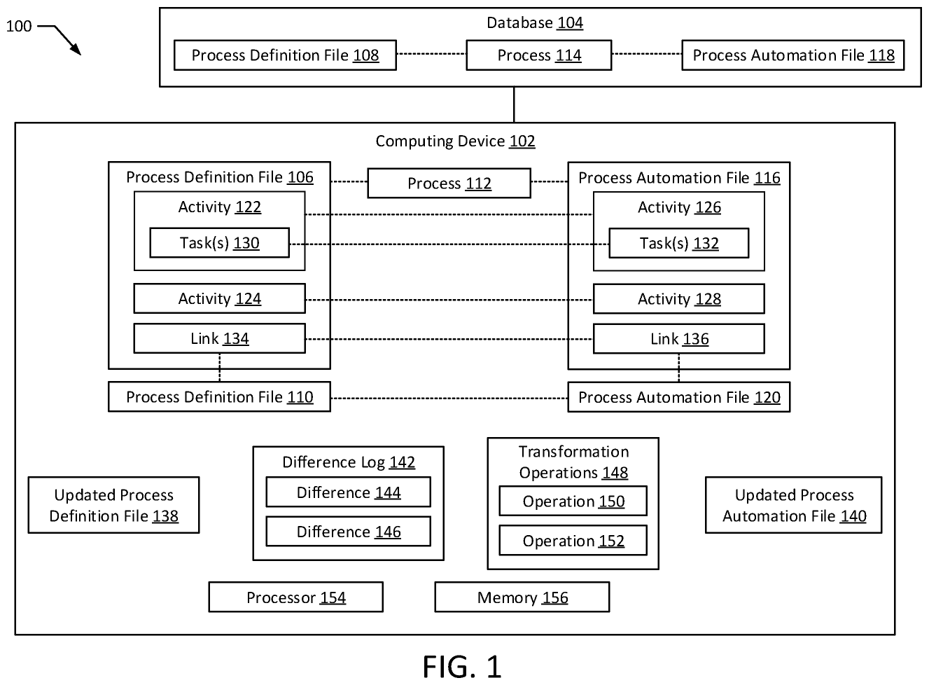

FIG. 1 illustrates a system 100 for computing process update propagation according to an exemplary embodiment of the present disclosure. The system 100 includes a computing device 102 and a database 104. The computing device 102 may be configured to maintain updated versions of process definition files 106 and process automation files 116 corresponding to a process 112 (e.g., a business process, a computing process, a computerized process, a computer-implemented process, a computer automated process). The database 104 may be configured to store process definition files 108 and process automation files 118 in association with corresponding processes 114. In particular, the database 104 may store multiple process definition files 108 and multiple process automation files 118 that are associated with multiple processes 114. In certain implementations, the computing device 102 may receive the process definition file 106 and/or the process automation file 116 from the database 104.

As mentioned above, the process definition file 106 may define the process 112 in a human-readable format. For example, the process definition file 106 may define the process 112 in a hierarchical structure that identifies the steps necessary to perform the process 112. For instance, the process definition file 106 may include one or more activities 122, 124, tasks 130, and links 134. Tasks 130 may include individual actions or decisions that must be performed during the process 112. Activities 122, 124 may include higher-level actions or goals to be completed according to the process 112. Certain activities 122 may be formed from multiple tasks 130. For example, where the process 112 is a sales process, the activity 122 may include determining a total for the sale and the activity 124 may include computing sales tax for the sale. Continuing this example, the tasks 130 for the activity 122 may include adding together the total purchase price for all goods purchased, applying any customer coupons, applying existing store discounts, and determining whether the customer qualifies for any rewards. Links 134 may incorporate details from other processes. For example, the link 134 may refer to a process definition file 110 for another process. As a specific example, the link 134 may incorporate a process definition file 110 for a process that generates and sends a sales order to a customer. This process may then be performed as part of the process 112. The hierarchical data structure of the process definition file 106 may be necessary to accurately define the process 112. For example, the activities 122, 124 may be performed according to their order within the process definition file 106 (e.g., the activity 122 may be performed before the activity 124). Similarly, tasks 130 within activities 122 may be performed according to their order within the activity 122. Therefore, changes to this hierarchical data structure may result in a different process definition and/or changes to the process 112.

The process automation file 116 may include an executable implementation of all or part of the process definition file 106. Originally, the process automation file 116 may be used to automate the implementation of all or part of the process 112. In particular, the process automation file 116 may include activities 126, 128, tasks 132, and/or links 136, similar to the activities 122, 124, tasks 130, and links 134 of the process definition file 106. In particular, the activity 126 may include an executable implementation of the activity 122, the tasks 132 may include executable implementations of the tasks 130, and the activity 128 may include an executable implementation of the activity 124. The link 136 may refer to a process automation file 120 that corresponds to the process definition file 110. In particular, the process automation file 116 may automatically perform all or part of the process 112 defined by the process definition file 110.

Although similar in hierarchical structure, in practice, process definition files 106 and process automations files 116 may differ in several aspects. First, as explained above, the process definition file 106 may describe the process 112 in a human-readable format and may include, for all or part of each element, a name of the element, an owner of the element, and a description of the processing performed for each element. By contrast, the process automation file 116 may contain executable instructions (e.g., machine code, workflows, byte code, source code) that, when executed, cause a computing device to perform all or part of the process (e.g., all or part of the process described in a corresponding element of the process definition file 106). Accordingly, process definition files 106 and process automation files 116 may utilize different file formats. For example, process definition files 106 may be implemented using structured data formats, such as XML, JSON, YAML, and the like. As another example, process automation files 116 may be implemented using executable workflow files, such as workflows for Nintex® Workflow Cloud and the like. One skilled in the art may recognize additional or alternative file format implementations for the process definition files 106 and/or process automation files 116 (e.g., alternative structured data formats, alternative executable workflow formats). All such formats are hereby considered within the scope of the present disclosure.

The computing device 102 may generate a mapping between the process definition file 106 and the process automation file 116. The mapping is depicted in FIG. 1 as dashed lines between corresponding elements of the process definition file 106 and the process automation file 116. In practice, the mapping may be stored as a data structure that includes pairs of unique identifiers for individual elements of the process definition file 106 and the process automation file 116 that correspond to one another. The computing device 102 may generate the mapping based on hierarchical data structures of the process definition file 106 and the process automation file 116. For example, the mapping may be generated by identifying corresponding top-level elements within the process definition file 106 and the process automation file 116 based on the order of these elements within the files 106, 116, respectively. For example, the computing device 102 may identify the first top-level element (i.e., activity 122) of the process definition file 106 as corresponding to the first top-level element (i.e., activity 126) of the process automation file 116. The computing device 102 may then generate and store a mapping between these two elements. The computing device 102 may similarly determine a mapping between the second top-level elements (i.e., activities 124, 128) and the third top-level elements (i.e., links 134, 136). The computing device 102 may then repeat this process for child elements of the top-level elements (e.g., tasks 130, 132). In certain instances, the computing device 102 may be configured to automatically generate the process automation file 116 upon receiving the process definition file 106. In such instances, the computing device 102 may generating the mapping by storing indications of elements of the process definition file 106 and corresponding elements of the process automation file 116 when the corresponding elements are created by the computing device 102.

The computing device 102 may receive an updated process definition file 138. In particular, the updated process definition file 138 may include changes to all or part of the process definition file 106. For example, a process definition file may be changed by one or more of: changing attribute values (e.g., inputs to one or more tasks or activities), adding or removing elements (e.g., tasks, activities, links), changing elements (e.g., tasks, activities, links), changing the order of tasks within an activity, changing the order of activities or links within the process definition file, and/or changing the dependency of elements (e.g., moving tasks from one activity to another, moving activities from one activity to another, moving links from one activity to another).

The computing device 102 may generate a difference log 142 based on the updated process definition file 108. In particular, the computing device 102 may compare the updated process definition file 138 two the process definition file 106 to identify one or more differences 144, 146 that are included within the difference log 142. In certain implementations, the computing device 102 may generate the difference log 142 using a “diff” command with the process definition file 106 and the updated process definition file 138 as inputs. Additionally or alternatively, the computing device 102 (or another computing device) may monitor user actions as a user modifies the process definition file 106 to create the updated process definition file 138. These editing actions may be included within the difference log 142. In such instances, the computing device 102 may receive the difference log 142 with the updated process definition file 138 (e.g., when the user edits the process definition file 106 on another computing device). Each of the differences 144, 146 may correspond to individual changes to the process definition file 106 reflected in the updated process definition file 138. For example, the difference 146 may correspond to a task that was moved from activity 122 to the activity 124, and the difference 144 may include a new activity that was added to the process definition file 106.

The computing device 102 may generate transformation operations 148 based on the difference log 142. In particular, the transformation operations 148 may be generated as an ordered list of changes that are to be applied to the process automation file 116 to generate an updated process automation file 140 that reflects the changes in the updated process definition file 138. In particular, the transformation operations 148 may be generated as a plurality of operations 150, 152, which may be performed to implement the differences 144, 146 reflected in the difference log 142. The operations 150, 152 may correspond to one or more of the differences 144, 146. Furthermore, the order in which the operations 150, 152 are performed may differ from the order of the differences 144, 146 within the difference log 142. For example, the operation 152 may correspond to the difference 144 and the operation 150 may correspond to the difference 146. As a specific example, the operation 150 may be performed to remove a task from the activity 126 to the activity 128 and the operation 152 may be performed to add a new activity to the updated process automation file 140.

The computing device 102 may then apply the transformation operations 148 to the process automation file 116 to generate the updated process automation file 140. The computing device 102 may then update the mapping between the updated process definition file 138 and the updated process automation file 140. The updated process automation file 140 may then be deployed within a computing environment (e.g., a distributed computing environment, a cloud computing environment) used to automatically implement the process 112 so that the updated version of the process 112 is used moving forward. In still further implementations, the computing device 102 may be used to deploy the updated process automation file 140. Additionally or alternatively, copies of the updated process definition file 138 and/or the updated process automation file 140 may be stored within the database 104.

In the example discussed above, an updated process definition file 138 was received and then used to generate to the difference log 142, transformation operations 148, and the updated process automation file 140. In practice, the computing device 102 may, in certain instances, receive an updated process automation file 140 instead of the updated process definition file 138. In such instances, the updated process automation file 140 may be used to generate the difference log 142 (e.g., by comparing the updated process automation file 140 to the process automation file 116). The difference log 142 may then be used to generate transformation operations 148 that are applied to the process definition file 106 to generate the updated process definition file 138 based on the updated process automation file 140. In certain instances, updated process definition files 138 and/or updated process automation files 140 may be received from another computing device, such as a computing device operated by a user that generated the updated process definition file 138 and/or updated process automation file 140. In additional or alternative implementations, a user may operate the computing device 102 to generate the updated process definition file and/or updated process automation file 140.

Similarly, it should be understood that, although many of the examples discussed herein focus on mappings between process definition files and process automation files, in practice mappings may similarly be made between two different process definition files. For example, mappings can be made between all or part of two different process definition files that share at least portions of the same business logic or decisions (e.g., in lieu of relying on links to external process definition files). In such instances, techniques similar to those discussed above (e.g., generating and applying an ordered list of transformations) may be used to synchronize changes from one process definition file to a corresponding portion of another process definition file (e.g., based on a mapping between the two process definition files).

The computing device 102 also includes a processor 154 and a memory 156. The processor 154 and the memory 156 may implement one or more aspects of the computing device 102. For example, the memory 156 may store instructions which, when executed by the processor 154, may cause the processor 154 to perform one or more operational features of the computing device 102. The processor 154 may be implemented as one or more central processing units (CPUs), field programmable gate arrays (FPGAs), and/or graphics processing units (GPUs) configured to execute instructions stored on the memory 156. Although not depicted, the database 104 may similarly include a processor and/or a memory configured to implement one or more operational features of the database 104. Additionally, the computing device 102 may be configured to communicate (e.g., with the database 104, to receive the updated process definition file 138 and/or the updated process automation file 140) using a network. For example, the computing device 102 may communicate with the network using one or more wired network interfaces (e.g., Ethernet interfaces) and/or wireless network interfaces (e.g., Wi-Fi®, Bluetooth®, and/or cellular data interfaces). In certain instances, the network may be implemented as a local network (e.g., a local area network), a virtual private network, L1, and/or a global network (e.g., the Internet).

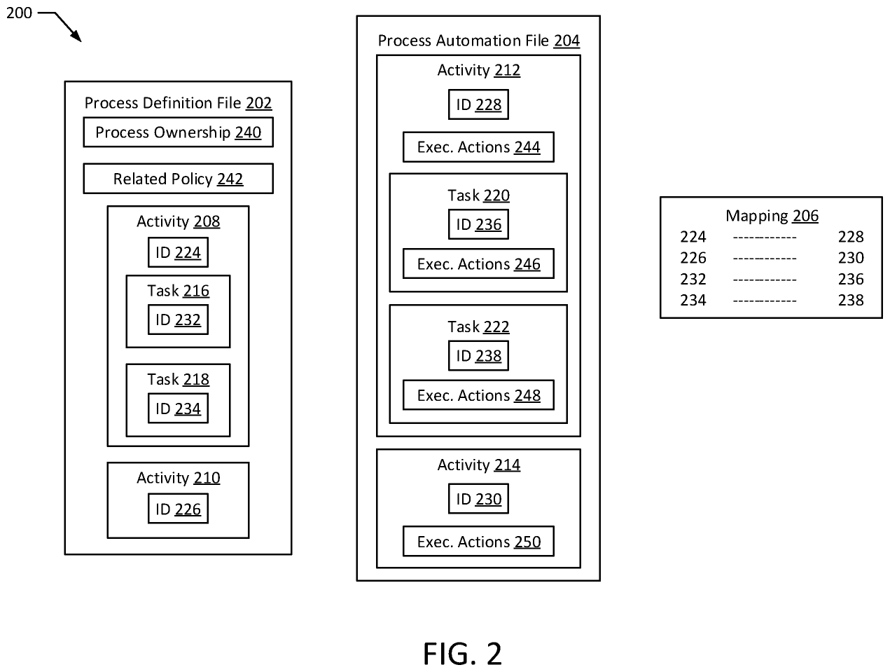

FIG. 2 illustrates a scenario 200 including an example process definition file and an example process automation file according to an exemplary embodiment of the present disclosure. The scenario 200 includes a process definition file 202, process automation file 204, and the mapping 206. The process definition file 202 may be an exemplary implementation of the process definition file 106, the process automation file 204 may be an exemplary implementation of the process automation file 116. The mapping 206 may indicate the corresponding elements within the process definition file 202 and the process automation file 204.

The process definition file 202 includes two activities 208, 210, process ownership 240, and a related policy 242. The activity 208 includes two tasks 216, 218. The process automation file 204 includes two activities 212, 214. The activity 214 further includes two tasks 220, 222. Each of the elements within the process definition file 202 and the process automation file 204 (e.g., activities 208, 210, 212, 214 and the tasks 216, 218, 220, 222) include corresponding unique identifiers (IDs) 224, 226, 228, 230, 232, 234, 236, 238. The unique identifiers 224, 226, 228, 230, 232, 234, 236, 238 may be generated (e.g., by a computing device 102) to uniquely identify each of the elements within the process definition file 202 and a process automation file 204. The IDs 224, 226, 228, 230, 232, 234, 236, 238 may then be used to identify the elements in subsequent operations (e.g., mappings, difference logs, transformation operations).

In particular, the IDs 224, 226, 228, 230, 232, 234, 236, 238 may be used to identify corresponding elements within the mapping 206. For example, the activity 208 in the process definition file 202 may correspond to the activity 212 in the process automation file 204 and the activity 210 may in the process definition file 202 may correspond to the activity 214 in the process automation file 204. The task 216 within the process definition file 202 may correspond to the task 220 within the process automation file 204 and the task 218 within the process definition file 202 may correspond to the task 222 within the process automation file 204. To indicate these corresponding elements, the mapping 206 may store pairs of IDs for corresponding elements. In particular, the mapping 206 may store the ID 224 of the activity 208 in association with the ID 228 of the activity 212. The mapping 206 may also store the ID 226 of the activity 210 in association with the ID 230 of the activity 214. Further, the mapping 206 may store the ID 232 of the task 216 in association with ID 236 of the task 220 and may store the ID 234 of the task 218 in association with the ID 238 of the task 222.

As explained above, process definition files and process automation files may store different types of information. For example, the contents of the activities 208, 210 and tasks 216, 218 within the process definition file 202 may differ from the contents of the corresponding activities 212, 214 and tasks 220, 222 within the process automation file 204. For example, the activities 208, 210 may include human-readable explanations of the analysis performed for each of the activities 208, 210 (e.g., an explanation of the data input, stakeholders, process owners, associated documents). Similarly, the tasks 216, 218 may include human-readable explanations for each of the tasks (e.g., data input, decision metrics, decision flows and flowcharts). The process definition file 202 may further include process ownership information 240 and one or more related policies 242. The process ownership 240 may identify one or more individuals or organizations (e.g., committees, departments, task forces) responsible for creating and updating the process definition file 202. The related policy 242 may identify one or more corresponding documents (e.g., legal documents, management documents) that outline or further detail the corresponding process. For example, where the process definition file 202 is intended to serve as a hierarchical definition of the process that may be used to generate and maintain process automation files (e.g., an XML file), the related policy 242 may be generated as a written document (e.g., PDF, Word file, presentation) used to document the corresponding process for a different audience (see, legal team, management staff, and the like). By contrast to the process definition file 202, the process automation file 204 may contain executable actions 244, 246, 248, 250 for each of the activities 212, 214 and tasks 220, 222. The executable actions 244, 246, 248, 250 may include machine executable instructions that may be performed by a computing device to implement corresponding activities 212, 214 and tasks 220, 222. In certain implementations, the executable actions 244, 246, 248, 250 may be stored as compiled machine code for execution by the computing device. In additional or alternative implementations, the executable actions 244, 246, 248, 250 may be stored as user-configurable workflows (e.g., Nintex ® Workflow Cloud workflows). Furthermore, the process automation file 204 may exclude process ownership information 240 and/or related policies 242.

One skilled in the art should understand that other implementations of process definition files, process automation files, and mappings may differ from those depicted in FIG. 2. For example, process definition files 202 may include additional information, such as relevant company departments, associated legal agreements, governing laws or regulations, and the like. Similarly, and process automation files 204 may not directly contain executable actions, but may reference one or more function libraries storing the executable instructions that are performed to implement corresponding activities 212, 214 and tasks 220, 222.

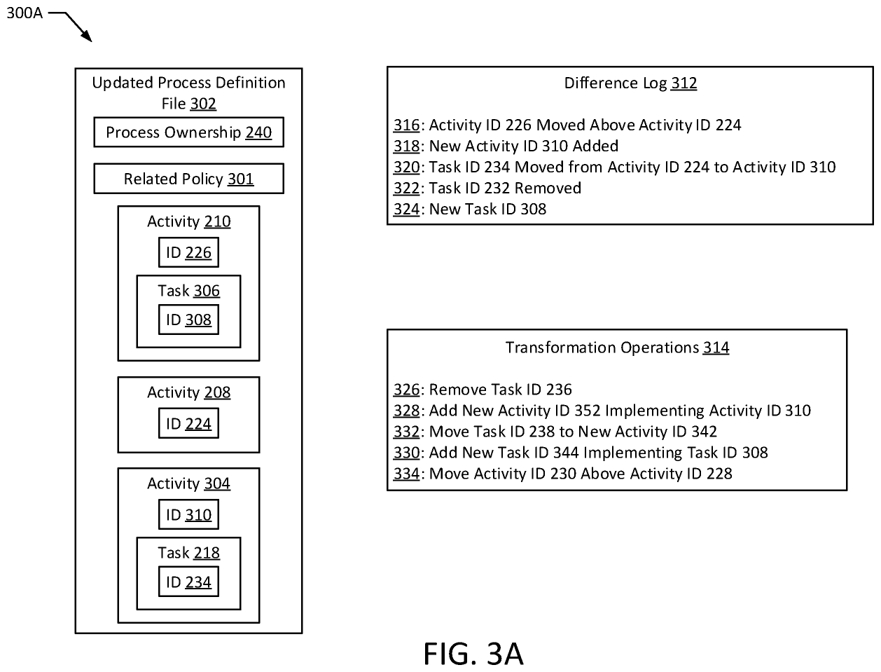

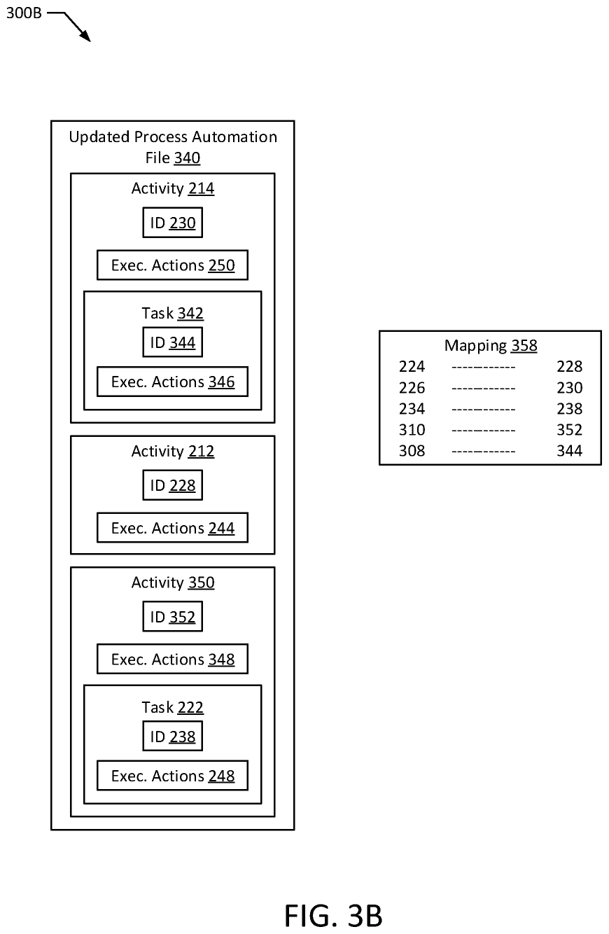

FIGS. 3A-3B illustrate scenarios 300A, B (collectively, “scenario 300”) including an exemplary computing process update propagation according to an exemplary embodiment of the present disclosure. In particular, the scenario 300 may reflect an exemplary update procedure of the process definition file 202 and the process automation file 204 based on a received updated process definition file 302. Starting with scenario 300A, a computing device (e.g., the computing device 102 may receive an updated process definition file 302. The updated process definition file 302 may be received from a user, as explained above. The updated process definition file 302 may represent an updated version of the process definition file 202 and may include one or more changes to the process definition file 202, discussed further below.

Upon receiving the updated process definition file 302, the computing device may generate a difference log 312 that identifies multiple differences 316, 318, 320, 322, 324 between the updated process definition file 302 and the process definition file 202. The differences 316, 318, 320, 322, 324 may be reflected within the difference log 312 in the order in which the differences 316, 318, 320, 322, 324 detected within the updated process definition file 302. In particular, the difference 316 indicates that the activity 210 with ID 226 and its order moved above of the activity 208 with ID 224. The next difference 318 may indicate that there is a new activity 304 with ID 310 added to the updated process definition file 302. Further, the difference 320 may indicate that the task 218 with ID 234 was moved from activity 208 with ID 224 to the new activity 304 with ID 310. The difference 322 may indicate that the task 216 with ID 232 was removed from the project definition file 202. Lastly, the difference 324 may indicate that a new task 306 with ID 308 was added to the activity 210.

Based on the differences 316, 318, 320, 322, 324 within the difference log 312, the computing device may generate one or more transformation operations. Transformation operations 314 may include an ordered list of operations 326, 328, 330, 332, 334. Each of the operations 326, 328, 330, 332, 334 may correspond to one or more of the differences 316, 318, 320, 322, 324 within the difference log 312. For example, the operation 326 may correspond to the difference 322, the operation 328 may correspond to difference 318, the operation 330 may correspond to difference 324, the operation 332 may correspond to difference 320, and operation 334 may correspond to difference 316. As can be seen in FIG. 3A, in certain instances, the order of the operations 326, 328, 330, 332, 334 within the transformation operations 314 may differ from the order of corresponding differences 316, 318, 320, 322, 324 within the difference log 312. Determining the order of the operations 326, 328, 330, 332, 334 within the transformation operations 314 is discussed in greater detail below in connection with the method 500 and FIG.

5.

The operations 326, 328, 330, 332, 334 may be generated based on the contents of the corresponding differences 316, 318, 320, 322, 324. For example, certain differences 316, 318, 320, 322, 324 may contain IDs with corresponding identifiers within the mapping 206. As a specific example, the difference 316 indicates that the activity 210 with ID 226 and its order changed in a structural hierarchy. The computing device may identify the ID 230 for the corresponding activity 214 within the mapping 206 and may generate corresponding operation 334 for this ID 230. The computing device may also identify the ID 228 corresponding to the ID 224 identified within the difference 316. In particular, the operation 334 may be generated to change the order in the structural hierarchy of the activity 210 with ID 230 above the activity 214 with ID 228 based on the corresponding IDs identified within the mapping 206 and the contents of the difference 316. In particular, in addition to identifying corresponding IDs within the mapping 206, the computing device may be configured to recognize one or more keywords within differences 316, 318, 320, 322, 324. For example, the computing device may be configured to recognize one or more of “add,” “remove,” “move,” “new,” “order,” and the like. Each of the keywords and/or particular combinations of the keywords may correspond to particular types of operations 326, 328, 330, 332, 334. As a specific example, the difference 316 includes the words “moved above,” which may correspond to rearranging one or more tasks or activities (e.g., identified based on corresponding IDs and the difference 316). The computing device may thus generate the operation 334 to rearrange the activities with corresponding IDs 230, 228 within the process automation file 204. In this way, the computing device may proceed with generating operations for all or part of the differences identified within the difference log 312. As defined above, the transformation operations 314 may represent an ordered list of operations. In certain implementations, the computing device may process the differences 316, 318, 320, 322, 324 based on a predetermined order for the transformation operations 314.

Turning to scenario 300B, the computing device may apply the transformation operations 314 to the process automation file 204 in order to generate the updated process automation file 340. In particular, the transformed operations 314 may be applied the order reflected in FIG. 3A. First, the task 220 with ID 236 may be removed from the process automation file 204. Then, a new activity 350 with ID 352 may be added to the updated process automation file 340. Adding the new activity 350 may include generating one or more executable actions 348 that implement the corresponding activity 304 within the updated process definition file 302. In certain implementations, the executable action 348 may be automatically generated based on the contents of the activity 304 (e.g., based on pseudocode or source code contained within the activity 304). In additional or alternative implementations, the executable actions 348 may be received from a user (e.g., in response to a system query for implementing executable actions). For example, a user may be prompted to create a workflow in a workflow software (e.g., Nintex Workflow Cloud that implements the activity 350. In presenting the query, the computing device may include portions of the process definition file 302 (e.g., contents of the activity 304).

Next, the task 222 with ID 238 may be moved to the new activity 350 with ID 352. Moving the task 222 may include rearranging the contents of the process automation file 340 (e.g., moving the contents corresponding to the task 222 to be contained within the contents of the activity 350). Additionally or alternatively, rearranging the task 222 may include reassigning a parent node for the task 222 from an identifier 228 of the activity 212 to the identifier 352 of the new activity 350. A new task 342 with ID 308 may then be added to the activity 214 with ID 230. New executable actions 346 may be created for the new task 342. The executable actions 346 may be implemented using techniques similar to those discussed above in connection with generating the executable actions 348. Lastly, the activity 214 with ID 230 may be moved above the activity 212 with ID 228. Rearranging the activities 212, 214 may include moving the contents of the activity 214 (e.g., including the contents of the new task 342) above contents of the activity 212 within the updated process automation file 340. Additionally or alternatively, the updated process automation file 340 may separately store ordered information for activities and other contents. In such instances, an identifier 230 of the activity 214 may be moved above an identifier 228 of the activity 212 within the ordered information. The updated process automation file 340 may then be used in future times to implement and automate the corresponding process in response to requests or other triggering actions for the process.

The computing device may also update the mapping 206. In particular, the computing device 350 may generate an updated mapping 358. The updated mapping 358 may be generated using techniques similar to those used to generate the mapping 206. Additionally or alternatively, the updated mapping 358 may be created by removing identifiers with associated “remove” operations 326 and adding new entries for identifiers with associated “add” operations 328, 330. For example, based on the operation 326, the association between IDs 232, 236 may be removed from the mapping 206 when creating the updated mapping 358. As another example, new entries may be made to the updated mapping 358 based on operations 328, 330. In particular, a new ID 352 may be added to the updated mapping 358 in association with the ID 310 for the new activities 304, 350 based on the operation 328. Similarly, a new ID 344 may be added to the updated mapping 358 in association with the ID 308 based on the operation 330.

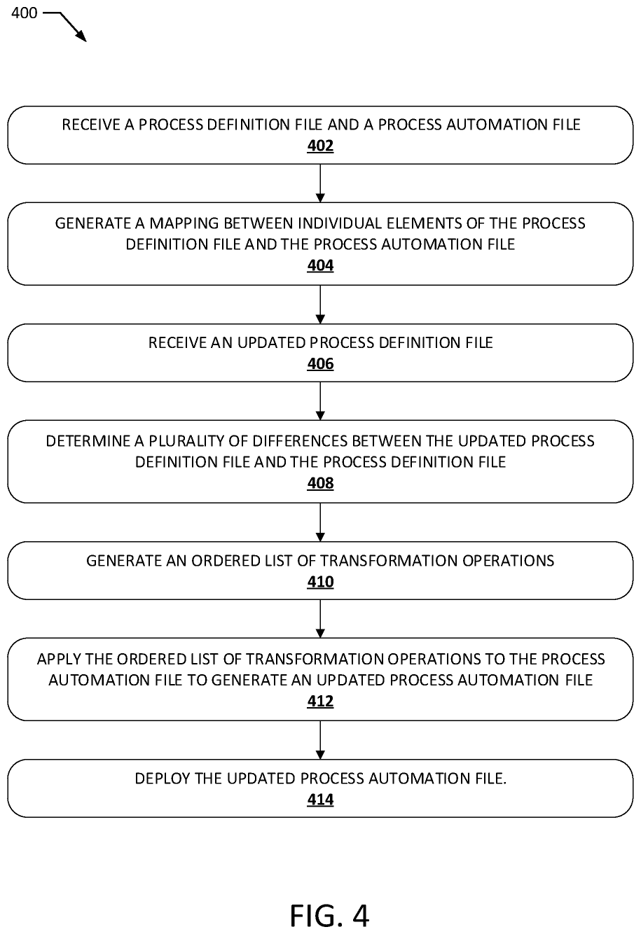

FIG. 4 illustrates a method 400 for propagating computing process according to an exemplary embodiment of the present disclosure. The method 400 may be implemented on a computer system, such as the system 100. For example, the method 400 may be implemented by the computing device 102. The method 400 may also be implemented by a set of instructions stored on a computer readable medium that, when executed by a processor, cause the computer system to perform the method 400. For example, all or part of the method 400 may be implemented by the processor 154 and the memory 156. Although the examples below are described with reference to the flowchart illustrated in FIG. 4, many other methods of performing the acts associated with FIG. 4 may be used. For example, the order of some of the blocks may be changed, certain blocks may be combined with other blocks, one or more of the blocks may be repeated, and some of the blocks described may be optional.

The method 400 may begin with receiving a process definition file and a process automation file (block 402). For example, the computing device 102 may receive a process definition file 106, 202 and a process automation file 116, 204. As explained above, the process definition file 106, 202 may define, in human-readable terms, a corresponding process 112. The process definition file 106, 202 may be at least partially implemented by the process automation file 116, 204. In particular, the process automation file 116, 204 may include executable actions 244, 246, 248, 250 that may be executed by the computing device 102 or another computing device to at least partially implement the process 112. The process automation file 116, 204 may execute in a distributed computing environment, such as a distributed computing environment containing the computing device 102. In certain implementations, the process automation file 116, 204 may be executed as a cloud computing function in response to received requests. For example, the process 112 may be a process for generating pay stubs on a regular basis for employees. The process definition file 106, 202 may describe the processes required and may include one or more activities 122, 124, 208, 210 implemented by one or more tasks 130, 216, 218. For example, the process definition file 106, 202 may include activities 122, 124, 208, 210 that define one or more of: determining an hourly pay rate for an employee, determining total hours worked for a pay period for the employee, determining overtime worked by the employee, determining a total amount of regular wages earned by the employee, determining a total amount of overtime wages earned by the employee, determining a tax withholding amount for the employee, retrieving direct deposit information for the employee, and generating a payment transaction to the employee's bank account.

A mapping may be generated between individual elements of the process definition file and the process automation file (block 404). For example, the computing device 102 may generate a mapping 206 between individual elements of the process definition file 106, 202 and the process automation file 116, 204. For example, the mapping 206 may identify corresponding elements in the process definition file 106, 202 for each of the elements in the process automation file 116, 204. Elements may include one or more of activities, tasks, and/or links. As explained above, elements within process definition files 106, 202 and process automation files 116, 204 may be assigned unique identifiers (e.g., the unique identifier may be previously assigned and/or the computing device 102 may generate unique identifiers for the elements). The mapping 206 may identify the corresponding elements by storing pairs of associated identifiers for corresponding elements within the process definition file 106, 202 and the process automation file 116, 204.

An updated process definition file may be received (block 406). For example, the computing device 102 may receive an updated process definition file 138, 302 from a user or other computing device. The updated process definition file 138, 302 may include an updated version of the process 112, and may include changes to one or more of the activities, tasks, and links contained within the process definition file 106. A plurality of differences may be determined between the updated process definition file and the process definition file (block 408). For example, the computing device 102 may determine a plurality of differences between the updated process definition file 138, 302 and the process definition file 106, 202. In certain instances, the plurality of differences may be determined in a difference log 142, 312 (e.g., based on a “diff” or other comparison command between the updated process definition file 138, 302 and the process definition file 106, 202, based on editing actions performed by a user to create the updated process definition file 138, 302). The differences may then be recorded as individual entries within the difference log 142, 312. For example, the computing device 102 may determine that the updated process definition file 138, 302 includes one new activity, changes one activity, removes an activity, and adds a link. For example, where the process definition file 106 defines a process for generating pay stubs, the updated process definition file 138, 302 may include changes to the activity for determining overtime hours worked (e.g., in response to changing regulations that lower the number of hours required to receive overtime compensation). As another example, the updated process definition file 138, 302 may include additional activities performed to determine when an employee has worked an excessive number of overtime hours (e.g., in response to a change in internal policy regarding maximum number of overtime hours). In particular, the updated process definition file 138, 302 may include totaling the number of overtime hours worked in the last three months and determining whether the total number exceeds a predetermined threshold. As a further example, the activity that defines policies for generating payment transactions to employee bank accounts may be replaced with a link to a standardized process definition file for the payment transaction process (e.g., stored in the database 104).

An ordered list of transformation operations may be generated (block 410). For example, the computing device 102 may generate an ordered list of transformation operations 148, 314 based on the differences identified within the difference log 142, 312. As explained above, each of the transformation operations 148, 314 may correspond to one or more particular differences within the difference log 142, 312. Each of the operations generated for the transformation operations 148, 314 may be generated by identifying a corresponding ID for elements that are changed, moved, or removed within the updated process definition file 138, 302 and/or by generating (or querying a user to provide) new corresponding versions of new elements that are added to the process definition file. Based on the corresponding IDs and the types of changes reflected in the difference log 142, 312, the computing device 102 may generate operations to update the corresponding elements within the process automation file 116, 204. Individual operations 150, 152, 326, 328, 330, 332, 334 may be generated and/or ordered within the transformation operations 148, 314 according to a predetermined priority. For example, as explained further below, elements that are added, removed, or changed may be updated based on whether they are parent elements or child elements.

The ordered list of transformation operations may be applied to the process automation file to generate an updated process automation file (block 412). For example, computing device 102 may apply the ordered list of transformation operations 148, 314 to the process automation file 116, 204 to generate an updated process automation file 140, 340. In particular, the ordered list of transformation operations 148, 314 may be applied by implementing the individual operations 150, 152, 326, 328, 330, 332, 334 according to their ordering within the transformation operations 148, 314. The updated process automation file may then be deployed (block 414). For example, the computing device 102 may deploy the updated process automation file 140, 340 for future execution in order to automate all or part of the process 112 as updated.

In practice, the method 400 may be performed differently depending on the types of updated files received by the computing device 102. In particular, the method 400, or a similar method, may be performed to bidirectionally synchronize changes to either of the process definition file and the process automation file. For example, the computing device 102 may receive an updated process automation file instead of an updated process definition file at block 406. In such instances, blocks 408, 410 may be performed to identify differences in the updated process automation file and to generate a list of transformation operations for the process definition file. Further, the transformation operations may be applied to the process definition file at block 412 in order to generate an updated process definition file based on changes to the process automation file reflected in the process automation file. In such instances, the process automation file may be deployed at block 414 before or after all or part of the blocks 408, 410, 412 are performed. Similarly, as explained further above, in practice a mapping may exist between two or more process definition files. In such instances, the techniques of the method 400 may be performed to synchronize changes from one process definition file to another process definition file (e.g., by performing blocks 404-412 to generate and apply a mapping between the process definition files and to generate and apply an ordered list of transformation operations to apply the changes from one process definition file to a corresponding process definition file).

Accordingly, the method 400 enables the synchronization between multiple files that define a business process. In particular, by generating a mapping between individual elements of the process definition file into the process automation file, the method 400 enables the identification of corresponding elements that are changed or removed in a received updated file (e.g., updated process definition file, updated process automation file). Furthermore, by generating the ordered list of transformation operations based on the differences detected in the received updated file, the method 400 is able to ensure that changes in one file for a business process (e.g., process definition file, process automation file) are reflected in the other (e.g., process automation file, process definition file). These improvements ensure that automated versions of business processes continued to accurately perform according to the requirements defining the business processes. Further, where changes are made to a process that improve the process's efficiency (e.g., by reducing the number of processing steps, by reducing bandwidth or other computing resources), ensuring that these changes are automatically applied to automated versions of the business processes ensures that these changes are properly deployed, reducing the computing resources utilized by automated versions of this processes once updates are deployed.

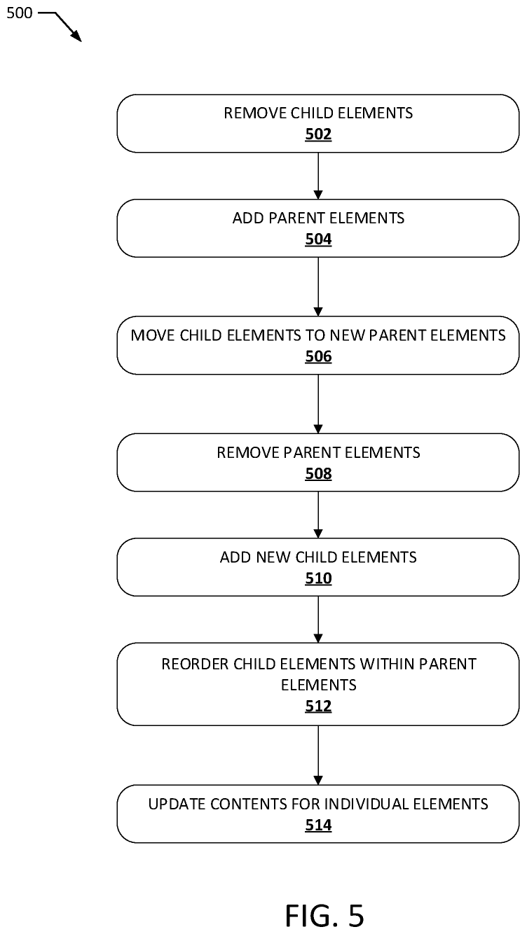

FIG. 5 illustrates a method 500 for generating and/or applying transformation steps according to an exemplary embodiment of the present disclosure. The method 500 may be implemented on a computer system, such as the system 100. For example, the method 500 may be implemented by the computing device 102. In particular, the method 500 may be performed by the computing device 102 in order to generate transformation operations 148, 314 in a predetermined order (e.g., at block 410). Additionally or alternatively, the method 500 may be performed to identify differences within a received updated file in a particular order (e.g., at block 408). The method 500 may also be implemented by a set of instructions stored on a computer readable medium that, when executed by a processor, cause the computer system to perform the method 500. For example, all or part of the method 400 may be implemented by the processor 154 and the memory 156. Although the examples below are described with reference to the flowchart illustrated in FIG. 5, many other methods of performing the acts associated with FIG. 5 may be used. For example, the order of some of the blocks may be changed, certain blocks may be combined with other blocks, one or more of the blocks may be repeated, and some of the blocks described may be optional.

As used throughout the present discussion, a “parent element” is an element of a process definition file and/or a process automation file that contains one or more other elements and/or an element that is not contained within another element. The parent element is a parent to the other elements that it contains. For example, the activity 208 is a parent element of tasks 216, 218. A “child element” is an element of a process definition file and/or a process automation that is contained within one or more other elements. The child element is a child to the element that contains it and is a “sibling element” to other elements contained within the same parent element. For example, tasks 216, 218 are each child elements of the activity 208. Further, the task 216 is a sibling element to the task 218, and vice versa. In practice, it should be understood that activities may contain other activities and/or that tasks may contain other tasks within process definition files and/or process automation files. Accordingly, an activity may, in certain implementations, be a child element of another activity. Similarly, an activity may be a parent element of another activity. As another example, a link may be a child element of activity. As a further example, a task to be a child element and/or a parent element of another task.

The method 500 may begin with removing child elements (block 502). For example, the first operations included in the ordered list of transformation operations 148, 314 may be those that remove child elements that correspond to child elements that are not present in the received updated file. At this stage, the child elements that are removed may be those that are not themselves parent elements. For example, the task 216 with ID 232 does not contain other elements and is removed within the updated process definition file 302. Accordingly, the first operation 326 in the transformation operations 314 may be to remove the corresponding task 220 with ID 236 from the process automation file 204.

New parent elements may then be added (block 504). For example, the next operations included in the ordered list of transformation operations 148, 314 may be those that add parent elements that are present in the updated file but are not present in the original file. For example, the updated process definition file 302 adds a new activity 304 with ID 310. Accordingly, the next operation 328 in the transformation operations 314 may be to add the new activity 350 with ID 352.

Child elements may be moved to new parent elements (block 506). For example, the next operations included in the ordered list of transformation operations 148, 314 may be those that move child elements that correspond to child elements in the received updated file that have different parent elements than in the original file. For example, task 218 with ID 234 was moved to a new parent element: activity 304 with ID 310. Accordingly, the next operation 330 in the transformation operations 314 may be to move the corresponding task 222 with ID 238 in the process automation file to the corresponding new activity 350 with ID 352.

Parent elements may be removed (block 508). For example, the next operations included in the ordered list of transformation operations 148, 314 may include those that remove parent elements that correspond to parent elements in the original file that are not present in the received updated file. For example, if activity 208 with ID 224 were removed in the updated process definition file 302, a corresponding operation in the transformation operations 148, 314 may be generated and added to remove the activity 212 with ID 228 from the updated process automation file 340.

New child elements may be added (block 510). For example, the next operations included in the ordered list of transformation operations 148, 314 may include those that add child elements that correspond to child elements in the updated file that are not present in the original file. For example, the updated process definition file adds new task 306 with ID 308, and a corresponding operation in the transformation operations 148, 314 may be generated and added to add the new task 342 with ID 344 to the updated process automation file 340.

Child elements may be reordered within parent elements (block 512). For example, the next operations included in the ordered list of transformation operations 148, 314 may include those that reorder child elements within parent elements that correspond to child elements in the updated file whose order differs from the process definition file. As a specific example, if an updated process automation file was received that moved task 222 with ID 238 above task 220 with ID 236 in the activity 212 with ID 228, a corresponding operation may be added to the transformation operations 148, 314 that moves corresponding task 218 with ID 234 above task 216 with ID 232 in the activity 208 in an updated process definition file. This process may then repeat for parent elements who are themselves child elements of another element, and may iterate for increasingly higher levels of parent elements. For example, a first activity may contain both a second activity and a third activity. The second activity may contain multiple tasks that are rearranged in an updated file and the third activity may be moved above the second activity within the first activity in the updated file. In such instances, operations may first be added to the transformation operations 148, 314 that rearrange the tasks within the second activity. Then, an operation may be added to the transformation operations 148, 314 that moves the third activity above the second activity.

Contents for individual elements may then be updated (block 514). For example, the next operations included in the ordered list of transformation operations 148, 314 may include those that update contents for individual elements that correspond to individual elements of the updated file whose contents differ from the original file. Updating the contents may include changing the contents of tasks within an activity, task, or link in a process definition file. Additionally or alternatively, updating the contents may include changing the executable actions contained within an activity or task in a process automation file. In certain instances, updating the contents may include changing other types of information, such as updating a related policy 301 and the updated process definition file 302.

Certain blocks within the method 500 may include more than one qualifying difference in the difference log 142, 312 and may therefore require more than one operation to be added to the transformation operations 148, 314. In such instances, the corresponding operations may be included within the ordered list of transformation operations 148, 314 in the order in which they occur in the difference log 142, 312, or using another selection strategy that may be readily apparent to one skilled in the art.

The method 500 may ensure that applying the transformation operations accurately transfers changes in a received updated file (e.g., updated process automation file, updated process definition file) to a corresponding file for the same business process (e.g., a new updated process definition file, a new updated process automation file). In particular, generating and/or performing the transformation operations in the order reflected in the method 500 (e.g., by following blocks 502-514 in the discussed and depicted order) may ensure that elements are not inadvertently deleted (e.g., by deleting a parent element) or incorrectly moved/rearranged (e.g., within a nonexistent new parent element. Accordingly, the method 500 ensures that changes to process automation files and process definition files can be accurately synchronized without having to perform unnecessary or redundant transformation operations. This accordingly reduces the computing resources required to synchronize these files and/or reduces latency in transferring changes in one file for a business process to another file for the same business process.

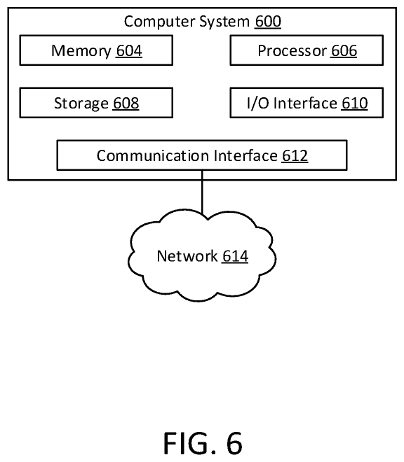

FIG. 6 illustrates an example computer system 600 that may be utilized to implement one or more of the devices and/or components discussed herein, such as the computing device 102 and/or the database 104. In particular embodiments, one or more computer systems 600 perform one or more steps of one or more methods described or illustrated herein. In particular embodiments, one or more computer systems 600 provide the functionalities described or illustrated herein. In particular embodiments, software running on one or more computer systems 600 performs one or more steps of one or more methods described or illustrated herein or provides the functionalities described or illustrated herein. Particular embodiments include one or more portions of one or more computer systems 600. Herein, a reference to a computer system may encompass a computing device, and vice versa, where appropriate. Moreover, a reference to a computer system may encompass one or more computer systems, where appropriate.

This disclosure contemplates any suitable number of computer systems 600. This disclosure contemplates the computer system 600 taking any suitable physical form. As example and not by way of limitation, the computer system 600 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, the computer system 600 may include one or more computer systems 600; be unitary or distributed; span multiple locations; span multiple machines; span multiple data centers; or reside in a cloud, which may include one or more cloud components in one or more networks. Where appropriate, one or more computer systems 600 may perform without substantial spatial or temporal limitation one or more steps of one or more methods described or illustrated herein. As an example and not by way of limitation, one or more computer systems 600 may perform in real time or in batch mode one or more steps of one or more methods described or illustrated herein. One or more computer systems 600 may perform at different times or at different locations one or more steps of one or more methods described or illustrated herein, where appropriate.

In particular embodiments, computer system 600 includes a processor 606, memory 604, storage 608, an input/output (I/O) interface 610, and a communication interface 612. Although this disclosure describes and illustrates a particular computer system having a particular number of particular components in a particular arrangement, this disclosure contemplates any suitable computer system having any suitable number of any suitable components in any suitable arrangement.

In particular embodiments, the processor 606 includes hardware for executing instructions, such as those making up a computer program. As an example and not by way of limitation, to execute instructions, the processor 606 may retrieve (or fetch) the instructions from an internal register, an internal cache, memory 604, or storage 608; decode and execute the instructions; and then write one or more results to an internal register, internal cache, memory 604, or storage 608. In particular embodiments, the processor 606 may include one or more internal caches for data, instructions, or addresses. This disclosure contemplates the processor 606 including any suitable number of any suitable internal caches, where appropriate. As an example and not by way of limitation, the processor 606 may include one or more instruction caches, one or more data caches, and one or more translation lookaside buffers (TLBs). Instructions in the instruction caches may be copies of instructions in memory 604 or storage 608, and the instruction caches may speed up retrieval of those instructions by the processor 606. Data in the data caches may be copies of data in memory 604 or storage 608 that are to be operated on by computer instructions; the results of previous instructions executed by the processor 606 that are accessible to subsequent instructions or for writing to memory 604 or storage 608; or any other suitable data. The data caches may speed up read or write operations by the processor 606. The TLBs may speed up virtual-address translation for the processor 606. In particular embodiments, processor 606 may include one or more internal registers for data, instructions, or addresses. This disclosure contemplates the processor 606 including any suitable number of any suitable internal registers, where appropriate. Where appropriate, the processor 606 may include one or more arithmetic logic units (ALUs), be a multi-core processor, or include one or more processors 606. Although this disclosure describes and illustrates a particular processor, this disclosure contemplates any suitable processor.

In particular embodiments, the memory 604 includes main memory for storing instructions for the processor 606 to execute or data for processor 606 to operate on. As an example, and not by way of limitation, computer system 600 may load instructions from storage 608 or another source (such as another computer system 600) to the memory 604. The processor 606 may then load the instructions from the memory 604 to an internal register or internal cache. To execute the instructions, the processor 606 may retrieve the instructions from the internal register or internal cache and decode them. During or after execution of the instructions, the processor 606 may write one or more results (which may be intermediate or final results) to the internal register or internal cache. The processor 606 may then write one or more of those results to the memory 604. In particular embodiments, the processor 606 executes only instructions in one or more internal registers or internal caches or in memory 604 (as opposed to storage 608 or elsewhere) and operates only on data in one or more internal registers or internal caches or in memory 604 (as opposed to storage 608 or elsewhere). One or more memory buses (which may each include an address bus and a data bus) may couple the processor 606 to the memory 604. The bus may include one or more memory buses, as described in further detail below. In particular embodiments, one or more memory management units (MMUs) reside between the processor 606 and memory 604 and facilitate accesses to the memory 604 requested by the processor 606. In particular embodiments, the memory 604 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 604 may include one or more memories 604, where appropriate. Although this disclosure describes and illustrates particular memory implementations, this disclosure contemplates any suitable memory implementation.

In particular embodiments, the storage 608 includes mass storage for data or instructions. As an example and not by way of limitation, the storage 608 may include a hard disk drive (HDD), a floppy disk drive, flash memory, an optical disc, a magneto-optical disc, magnetic tape, or a Universal Serial Bus (USB) drive or a combination of two or more of these. The storage 608 may include removable or non-removable (or fixed) media, where appropriate. The storage 608 may be internal or external to computer system 600, where appropriate. In particular embodiments, the storage 608 is non-volatile, solid-state memory. In particular embodiments, the storage 608 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 608 taking any suitable physical form. The storage 608 may include one or more storage control units facilitating communication between processor 606 and storage 608, where appropriate. Where appropriate, the storage 608 may include one or more storages 608. Although this disclosure describes and illustrates particular storage, this disclosure contemplates any suitable storage.

In particular embodiments, the I/O Interface 610 includes hardware, software, or both, providing one or more interfaces for communication between computer system 600 and one or more I/O devices. The computer system 600 may include one or more of these I/O devices, where appropriate. One or more of these I/O devices may enable communication between a person (i.e., a user) and computer system 600. As an example and not by way of limitation, an I/O device may include a keyboard, keypad, microphone, monitor, screen, display panel, mouse, printer, scanner, speaker, still camera, stylus, tablet, touch screen, trackball, video camera, another suitable I/O device or a combination of two or more of these. An I/O device may include one or more sensors. Where appropriate, the I/O Interface 610 may include one or more device or software drivers enabling processor 606 to drive one or more of these I/O devices. The I/O interface 610 may include one or more I/O interfaces 610, where appropriate. Although this disclosure describes and illustrates a particular I/O interface, this disclosure contemplates any suitable I/O interface or combination of I/O interfaces.

In particular embodiments, communication interface 612 includes hardware, software, or both providing one or more interfaces for communication (such as, for example, packet-based communication) between computer system 600 and one or more other computer systems 600 or one or more networks 614. As an example and not by way of limitation, communication interface 612 may include a network interface controller (NIC) or network adapter for communicating with an Ethernet or any other wire-based network or a wireless NIC (WNIC) or wireless adapter for communicating with a wireless network, such as a Wi-Fi network. This disclosure contemplates any suitable network 614 and any suitable communication interface 612 for the network 614. As an example and not by way of limitation, the network 614 may include one or more of an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 600 may communicate with a wireless PAN (WPAN) (such as, for example, a Bluetooth® WPAN), a WI-FI network, a WI-MAX network, a cellular telephone network (such as, for example, a Global System for Mobile Communications (GSM) network), or any other suitable wireless network or a combination of two or more of these. Computer system 600 may include any suitable communication interface 612 for any of these networks, where appropriate. Communication interface 612 may include one or more communication interfaces 612, where appropriate. Although this disclosure describes and illustrates a particular communication interface implementations, this disclosure contemplates any suitable communication interface implementation.

The computer system 602 may also include a bus. The bus may include hardware, software, or both and may communicatively couple the components of the computer system 600 to each other. As an example and not by way of limitation, the bus may include an Accelerated Graphics Port (AGP) or any other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-PIN-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local bus (VLB), or another suitable bus or a combination of two or more of these buses. The bus may include one or more buses, where appropriate. Although this disclosure describes and illustrates a particular bus, this disclosure contemplates any suitable bus or interconnect.

Herein, a computer-readable non-transitory storage medium or media may include one or more semiconductor-based or other types of integrated circuits (ICs) (e.g., field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, features, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

All of the disclosed methods and procedures described in this disclosure can be implemented using one or more computer programs or components. These components may be provided as a series of computer instructions on any conventional computer readable medium or machine readable medium, including volatile and non-volatile memory, such as RAM, ROM, flash memory, magnetic or optical disks, optical memory, or other storage media. The instructions may be provided as software or firmware, and may be implemented in whole or in part in hardware components such as ASICs, FPGAs, DSPs, or any other similar devices. The instructions may be configured to be executed by one or more processors, which when executing the series of computer instructions, performs or facilitates the performance of all or part of the disclosed methods and procedures.

It should be understood that various changes and modifications to the examples described here will be apparent to those skilled in the art. Such changes and modifications can be made without departing from the spirit and scope of the present subject matter and without diminishing its intended advantages. It is therefore intended that such changes and modifications be covered by the appended claims.

1. A method comprising:
receiving a process definition file and a process automation file, wherein each of the process definition file and the process automation file are associated with a particular computing process;
generating a mapping between individual elements of the process definition file and the process automation file;
receiving an updated process definition file;
determining a plurality of differences between the individual elements of the updated process definition file and individual elements of the process definition file;
generating an ordered list of transformation operations based on the plurality of differences;
applying the ordered list of transformation operations to the process automation file to generate an updated process automation file; and
deploying the updated process automation file.

2. The method of claim 1, wherein unique identifiers (IDs) are associated with at least a subset of the individual elements of the process definition file and at least a subset of the individual elements of the process automation file, and the mapping stores indications of corresponding elements in the process definition file and the process automation file as pairs of unique IDs.

3. The method of claim 1, wherein the individual elements of the process definition file and/or the individual elements of the process automation file include an ordered list of activities, tasks, and links, wherein activities may include one or more tasks, and wherein links may identify additional process definition files and/or process automation files necessary to define the particular computing process.

4. The method of claim 3, wherein the plurality of differences include at least one of an added activity, a removed activity, an added task, a removed task, an added link, a removed link, a change in hierarchical organization for an existing activity, a change in hierarchical organization for an existing task, and/or a change in hierarchical organization for an existing link.

5. The method of claim 1, wherein the ordered list of transformation operations to generate the updated process automation file comprises:
(1) removing child elements from the process automation file that correspond to child elements in the process definition file that are not present in the updated process definition file;
(2) adding parent elements to the process automation file that correspond to parent elements in the updated process definition file that are not present in the process definition file;
(3) moving child elements in the process automation file that correspond to child elements in the updated process definition file with different parent elements than in the process definition file;
(4) removing parent elements from the process automation file that correspond to parent elements in the process definition file that are not present in the updated process definition file;
(5) adding child elements to the process automation file that correspond to child elements in the updated process definition file that are not present in the process definition file;
(6) reordering child elements within parent elements of the process automation file that correspond to child elements in the updated process definition file that are ordered differently than in the process definition file; and
(7) updating contents for individual elements of the process automation file that correspond to individual elements of the updated process definition file whose contents differ from the process definition file.

6. The method of claim 5, wherein the ordered list of transformation operations are applied in order from (1) to (7).

7. The method of claim 5, wherein one or more of the transformation operations (1)-(7) are repeated from lower to higher levels of hierarchical organization of the updated process definition file.

8. The method of claim 5, wherein parent elements in the process definition file and/or the updated process definition file are individual elements within the process definition file and/or the updated process definition file that are higher in a hierarchical organization of the process definition file and/or the updated process definition file, and wherein parent elements in the process automation file and/or the updated process automation file are individual elements within the process automation file and/or the updated process automation file that are higher in a hierarchical organization of the process automation file and/or the updated process automation file.

9. The method of claim 1, wherein the plurality of differences are determined as at least one of (i) a difference log between the updated process definition file and the process definition file and/or (ii) an ordered list of editing actions performed by a user while updating the process definition file.

10. The method of claim 1, wherein each of the transformation operations corresponds to at least one difference of the plurality of differences.

11. The method of claim 10, wherein the order of transformation operations in the ordered list of transformation operations differs at least in part from the order of the differences in the plurality of differences.

12. The method of claim 1, wherein the process automation file implements a portion of the particular computing process and the mapping is generated between a corresponding portion of the process definition file and the process automation file.

13. The method of claim 12, wherein the ordered list of transformation operations is generated to include changes to the corresponding portion of the process definition file and exclude changes to other portions of the process definition file.

14. The method of claim 1, wherein the individual elements of the process definition file describe ownership, policies, and/or decisions for the particular computer processes, and wherein the individual elements of the process automation file are executable to perform the particular computing process.

15. A system comprising:
a processor; and
a memory storing instructions which, when executed by the processor, cause the processor to:
receive a process definition file and a process automation file, wherein each of the process definition file and the process automation file are associated with a particular computing process;
generate a mapping between individual elements of the process definition file and the process automation file;
receive an updated process automation file;
determine a plurality of differences between the individual elements of the updated process automation file and individual elements of the process automation file;
generate an ordered list of transformation operations based on the plurality of differences;
apply the ordered list of transformation operations to the process definition file to generate an updated process definition file; and
deploy the updated process automation file.

16. The system of claim 15, wherein unique identifiers (IDs) are associated with at least a subset of the individual elements of the process definition file and at least a subset of the individual elements of the process automation file, and the mapping stores indications of corresponding elements in the process definition file and the process automation file as pairs of unique IDs.

17. The system of claim 15, wherein the individual elements of the process definition file and/or the individual elements of the process automation file include an ordered list of activities, tasks, and links, wherein activities may include one or more tasks, and wherein links may identify additional process definition files and/or process automation files necessary to define the particular computing process.

18. The system of claim 17, wherein the plurality of differences include at least one of an added activity, a removed activity, an added task, a removed task, an added link, a removed link, a change in hierarchical organization for an existing activity, a change in hierarchical organization for an existing task, and/or a change in hierarchical organization for an existing link.

19. The system of claim 15, wherein the ordered list of transformation operations to generate the updated process definition file comprises:
(1) removing child elements from the process definition file that correspond to child elements in the process automation file that are not present in the updated process automation file;
(2) adding parent elements to the process definition file that correspond to parent elements in the updated process automation file that are not present in the process automation file;
(3) moving child elements in the process definition file that correspond to child elements in the updated process automation file with different parent elements than in the process automation file;
(4) removing parent elements from the process definition file that correspond to parent elements in the process automation file that are not present in the updated process automation file;
(5) adding child elements to the process definition file that correspond to child elements in the updated process automation file that are not present in the process automation file;
(6) reordering child elements within parent elements of the process definition file that correspond to child elements in the updated process automation file that are ordered differently than in the process automation file; and
(7) updating contents for individual elements of the process definition file that correspond to individual elements of the updated process automation file whose contents differ from the process automation file.

20. A method comprising:
receiving a first process definition file and a second process definition file, wherein each of the first process definition file and the second process definition file are associated with a particular computing processes;
generating a mapping between individual elements of the first process definition file and the second process definition file;
receiving a first updated process definition file representing an updated version of the first process definition file;
determining a plurality of differences between the individual elements of the first updated process definition file and individual elements of the first process definition file;
generating an ordered list of transformation operations based on the plurality of differences;
applying the ordered list of transformation operations to the second process definition file to generate a second updated process definition file; and
storing the second updated process definition file.
